(19) United States
(12) Patent Application Publication
(10) Pub. No.: US 2026/0322755 A1
(43) Pub. Date: Oct. 15, 2026

(54) COMMUNICATION APPARATUS, COMMUNICATION SYSTEM, COMMUNICATION METHOD, AND PROGRAM

(71) Applicant: NIPPON TELEGRAPH AND TELEPHONE CORPORATION, Tokyo (JP)

(72) Inventors: Hiroki IWASAWA, Tokyo (JP); Kazuhiro TOKUNAGA, Tokyo (JP); Takuya TOJO, Tokyo (JP); Seiya KOMATSU, Tokyo (JP)

(21) Appl. No.: 19/484,949

(22) PCT Filed: May 31, 2023
(86) PCT No.: PCT/JP2023/020279

§ 371 Date: Nov. 17, 2025

(51) Int. Cl. H04L 47/27; H04L 47/193; H04L 47/2483

(52) U.S. Cl. CPC H04L 47/27; H04L 47/193; H04L 47/2483

(57) ABSTRACT

A communication apparatus constitutes a communication system including a plurality of communication apparatuses connected via one or more networks, has a function of multiplexing a plurality of flows within a single transport connection and transferring the flows, and includes: a number-of-flows counting unit that counts the number of flows for each path in the transport connection; and a transmission control unit that adjusts a congestion window size for each path, based on the number of flows for each path acquired by the number-of-flows counting unit.

### TECHNICAL FIELD

The present invention relates to a communication system that connects communication apparatuses via one or more networks, multiplexes various kinds of communication within a single transport connection, and transfers the communication.

### BACKGROUND ART

As technologies in the related art in relation to communication systems that connect communication apparatuses via one or more networks, multiplex various kinds of communication within a single transport connection, and transfer the communication, HTTP/2, HTTP/3, QUIC, mechanisms of proxy and tunneling, apparatuses, and the like using them have been proposed (see Non-Patent Literature 1 to 4, for example).

In these technologies, communication is performed by multiplexing various communication flows having different requirements in connection of a single transport layer, such as TCP or QUIC.

### CITATION LIST

### Non-Patent Literature

Non-Patent Literature 1: “The MASQUE Protocol,” draft-schinazi-masque-00 https://datatracker.ietf.org/doc/html/draft-schinazi-masque-00
Non-Patent Literature 2: “Tunneling Internet protocols inside QUIC,” draft-piraux-quic-tunnel-03https://datatracker.ietf.org/doc/html/draft-piraux-quic-tunnel-03
Non-Patent Literature 3: “Enabling application policy-awareness in Multipath QUIC,” draft-an-multipath-quic-application-policy-00 https://datatracker.ietf.org/doc/html/draft-an-multipath-quic-application-policy-00 #ref-MPQUIC-Scheduler
Non-Patent Literature 4: Zhilong Zheng, Yunfei Ma, Yanmei Liu, Furong Yang, Zhenyu Li, Yuanbo Zhang, Jiuhai Zhang, Wei Shi, Wentao Chen, Ding Li, Qing An, Hai Hong, Hongqiang Harry Liu, Ming Zhang, “XLINK: QoE-Driven Multi-Path QUIC Transport in Large-scale Video Services,” SIGCOMM '21: Proceedings of the 2021 ACM SIGCOMM 2021 Conference August 2021 Pages 418-432 https://doi.org/10.1145/3452296.3472893

### SUMMARY OF INVENTION

### Technical Problem

However, the related art has a problem that it is not possible to obtain a sufficient throughput since a congestion window is adjusted for multiplexed communication similarly to the way for communication that has not been multiplexed when congestion occurs.

The present invention has been made in view of the above point, and an object of the present invention is to provide a technology that enables communication quality to be improved in a communication system that connects communication apparatuses via one or more networks, multiplexes various kinds of communication within a single transport connection, and transfers the communication.

### Solution to Problem

According to the disclosed technology, there is provided a communication apparatus that constitutes a communication system including a plurality of communication apparatuses connected via one or more networks, the communication apparatus having a function of multiplexing a plurality of flows within a single transport connection and transferring the flows, the communication apparatus including:
a number-of-flows counting unit that counts the number of flows for each path in the transport connection; and
a transmission control unit that adjusts a congestion window size for each path, based on the number of flows for each path acquired by the number-of-flows counting unit.

### Advantageous Effects of Invention

According to the disclosed technology, it is possible to improve communication quality in a communication system that connects communication apparatuses via one or more networks, multiplexes various kinds of communication within a single transport connection, and transfers the communication.

### BRIEF DESCRIPTION OF DRAWINGS

FIG. 1 is a diagram illustrating an overview of a technology in the related art.

FIG. 2 is a diagram illustrating an overview of a proposed technology.

FIG. 3 is a diagram illustrating a configuration example of a communication system according to an embodiment of the present invention.

FIG. 4 is a diagram illustrating a configuration example of a communication apparatus 100 according to an embodiment of the present invention.

FIG. 5 is a diagram illustrating a configuration example of a multiplexing transport unit 110.

FIG. 6 is a flowchart illustrating a basic transmission procedure executed by the communication apparatus 100.

FIG. 7 is a diagram for explaining a first embodiment.

FIG. 8 is a diagram for explaining the first embodiment.

FIG. 9 is a diagram for explaining a second embodiment.

FIG. 10 is a diagram for explaining the second embodiment.

FIG. 11 is a diagram for explaining a third embodiment.

FIG. 12 is a diagram for explaining a fourth embodiment.

FIG. 13 is a diagram illustrating a hardware configuration example of the communication apparatus 100.

### DESCRIPTION OF EMBODIMENTS

Hereinafter, embodiments of the present invention (present embodiment) will be described with reference to the drawings. The embodiments to be described below is merely examples, and embodiments to which the present invention is applied are not limited to the following embodiments.

A technology for improving quality of communication to be multiplexed in a communication system that connects communication apparatuses via one or more networks, multiplexes various kinds of communication within a single transport connection, and transfers the communication will be described below. Note that although a throughput is used as communication quality in the embodiment, the communication quality is not limited to the throughput.

Hereinafter, the technologies in the related art and problems thereof will be described in detail first, and the technology according to the present embodiment will then be described in detail. Note that, in regard to the technologies in the related art, although the technologies disclosed in the Non-Patent Literature are publicly known, explanation of the technologies in the related art and description of the problems given below are not publicly known.

### Concerning Technologies in Related Art

As technologies in the related art in relation to communication systems that connect communication apparatuses via one or more networks, multiplex various kinds of communication within a single transport connection, and transfer the communication, HTTP/2, HTTP/3, QUIC, mechanisms of proxy and tunneling, and apparatuses using them have been proposed as described above. In these technologies, communication is performed by multiplexing various communication flows having different requirements in connection of a single transport layer, such as TCP or QUIC. As specific technologies in the related art, the technologies 1 to 4 in the related art below will be described.

### <Technology 1 in Related Art: Multiplexed Application Substrate Over QUIC Encryption (MASQUE), 2020>

The technology 1 in the related art is a technology disclosed in Non-Patent Literature 1. MASQUE in the technology 1 in the related art is a mechanism that proxies a stream and datagram communication encrypted using HTTP and has been discussed by the standardization working group of IETF.

In MASQUE, an HTTP/3 proxy that has received a transfer request from a client transfers a QUIC stream frame or datagram frame to an original destination using a CONNECT method of HTTP including destination information (in the case of HTTP/2 or earlier, TCP or UDP is used).

### <Technology 2 in Related Art: Tunneling Internet Protocols Inside QUIC, 2019>

The technology 2 in the related art is a technology disclosed in Non-Patent Literature 2. The technology 2 in the related art defines the following scheme 1 and scheme 2 as tunneling schemes using QUIC.
Scheme 1: a transfer source packet is stored directly in a payload of a datagram frame. A signaling method is not particularly defined.
Scheme 2: a protocol type and a 2-byte tag are applied to a head of the datagram frame, and the transfer source packet is stored. Examples of use of the tag include a time stamp and a packet number.

In the technology 2 in the related art, a session participation method of a plurality of paths is also defined.

### <Technology 3 in Related Art: Application Policy-Awareness in Multipath QUIC, 2020>

The technology 3 in the related art is a technology disclosed in Non-Patent Literature 3. The technology 3 in the related art has proposed a framework of selecting a policy of packet scheduling (a path to be used, priority, presence/absence of redundancy) for each stream and performing transmission, based on stream intent information.

### <Technology 4 in Related Art: XLINK: QoE-Driven Multi-Path QUIC Transport in Large-Scale Video Services, 2021>

The technology 4 in the related art is a technology disclosed in Non-Patent Literature 4. The technology 4 in the related art has proposed a QUIC stream unit and a video frame packet scheduling scheme. According to the technology 4 in the related art, it is possible to prepare stream send API that enables the position, the size, and the priority of a video frame to be passed to a QUIC layer and perform resending/redundant transfer in units of video frames.

### Concerning Problems

Problems in the technologies in the related art will be described.

According to the technologies 1 and 2 in the related art, communication flows of various requirements are transferred to different servers. The technologies 3 and 4 in the related art have proposed a scheme of selecting a packet scheduling algorithm in accordance with a stream and a high-order application properties and performing control.

Applying the technologies 3 and 4 in the related art to the communication systems such as the technologies 1 and 2 in the related art in order to apply the packet scheduling algorithm to communication flows of various requirements is conceivable. However, although it is possible to select a path suitable for each stream even if the technologies 3 and 4 in the related art are applied to the communication systems such as the technologies 1 and 2 in the related art, a congestion control algorithm to determine the amount and the timing of data transmission for each path is not taken into consideration, and a requirement for each communication flow may not be able to be satisfied. In regard to the technology 3 in the related art, there is no description in regard to specific selection and control methods for packet scheduling.

In the technologies 1 and 2 in the related art, communication directed to a plurality of different servers is multiplexed within a single QUIC connection. However, since a congestion window is adjusted similarly to the way for the communication that has not been multiplexed at the time of occurrence of congestion, there is a problem that it is not possible to obtain a sufficient throughput.

Since multiplexed communication is determined as a single communication flow or communication flows corresponding to paths to be used in a middle box such as a router, there is a problem that it is not possible to obtain a sufficient throughput similar to the above in a case where fair control in units of flows such as Fair Queueing works.

### Overview of Embodiments

In the present embodiment, a communication apparatus 100, which will be described later, holds metadata for traffic control in units of flows (ex.: QUIC stream/datagram). The communication apparatus 100 independently controls congestion control, packet construction, and packet scheduling of QUIC in units of flows, based on the metadata for traffic control in units of flows.

Furthermore, the communication apparatus 100 can count the number of active flows and increase the total congestion window size of each path, based on the number of active flows.

Furthermore, the communication apparatus 100 can calculate a current throughput from an ACK frame, and if the current throughput is less than or equal to the total congestion window size of each path, the communication apparatus 100 can add a logical path by using a free port number and offload existing flows to a new path.

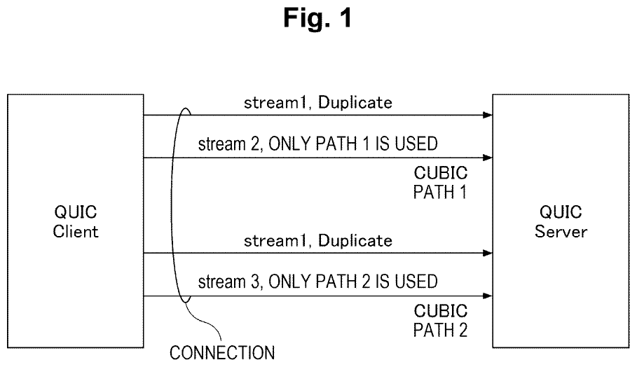

FIG. 1 illustrates an overview of a technology in the related art for comparison with the proposed technology. Note that FIG. 1 is not a publicly known diagram. As illustrated in FIG. 1, congestion control is unified in units of connections in the technology in the related art. Note that packet scheduling selection in units of streams can be performed by the technology 3 in the related art.

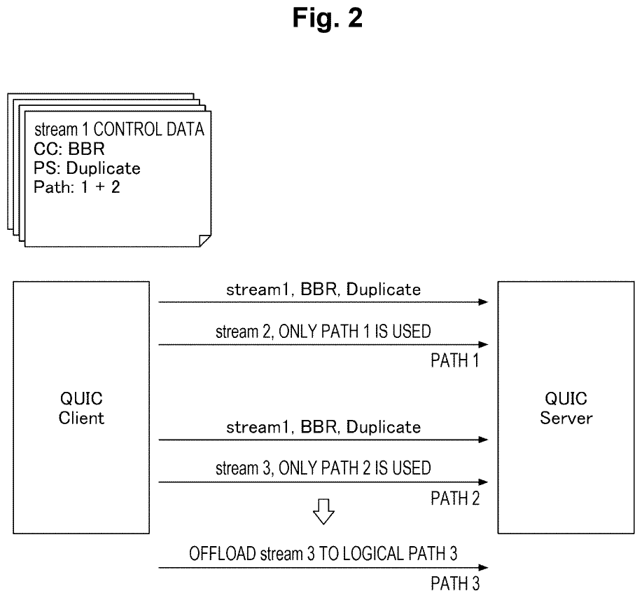

FIG. 2 is a diagram illustrating an overview of the proposed technology. In the example of FIG. 2, QUIC Client holds metadata for traffic control in units of flows. FIG. 2 illustrates metadata (control data) of a stream 1, which is a single flow. A congestion control method (CC) and a packet scheduling algorithm (PS) are designated in units of flows, based on the metadata. FIG. 2 also illustrates an image in which a logical path is added to offload a flow in a case where a throughput is not raised.

Hereinafter, configurations and operations of a system/apparatus according to the present embodiment will be described in detail.

### System Configuration Example

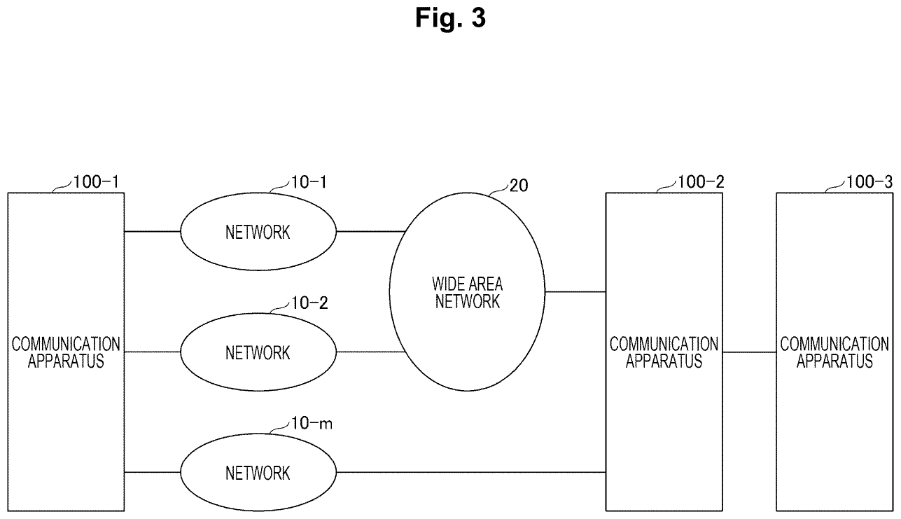

FIG. 3 illustrates a configuration example of the communication system according to the present embodiment.

As illustrated in FIG. 3, the communication system includes a communication apparatus 100-1, a communication apparatus 100-2, and a communication apparatus 100-3. The communication apparatus 100-1 and the communication apparatus 100-2 are connected via a plurality of networks 10-1 to 10-m. Furthermore, in the example of FIG. 3, the networks 10-1 and 10-2 connected to the communication apparatus 100-1 are connected to a wide area network 20, and the wide area network 20 is connected to the communication apparatus 100-2.

Communication in which a plurality of communication flows are multiplexed using a transport protocol, such as MPTCP or MPQUIC, is performed via one or more networks between the communication apparatus 100-1 and the communication apparatus 100-2.

The communication flow in the present embodiment means a series of related communication data. Specifically, the communication flow means, for example, “a packet group in which IP addresses in TCP/IP, port numbers, and 5-tuples of a protocol type are identical”, “stream data to be transmitted with the same stream ID in QUIC”, “a related datagram frame group such as a data group associated with a specific application or process in communication to be transmitted by a datagram frame”, or the like.

Any one of or both of two communication apparatuses that perform communication in the present embodiment may adopt a configuration of proxying communication from yet another communication apparatus, tunneling it, and transferring it to a counterpart multiplexed communication apparatus. FIG. 3 illustrates an example of such a case.

In other words, the communication apparatus 100-1 performs multiplexed communication with the communication apparatus 100-2 via one or more networks, and the communication apparatus 100-2 transfers data received from the communication apparatus 100-1 to the communication apparatus 100-3 in FIG. 3.

### Configuration Example of Communication Apparatus 100

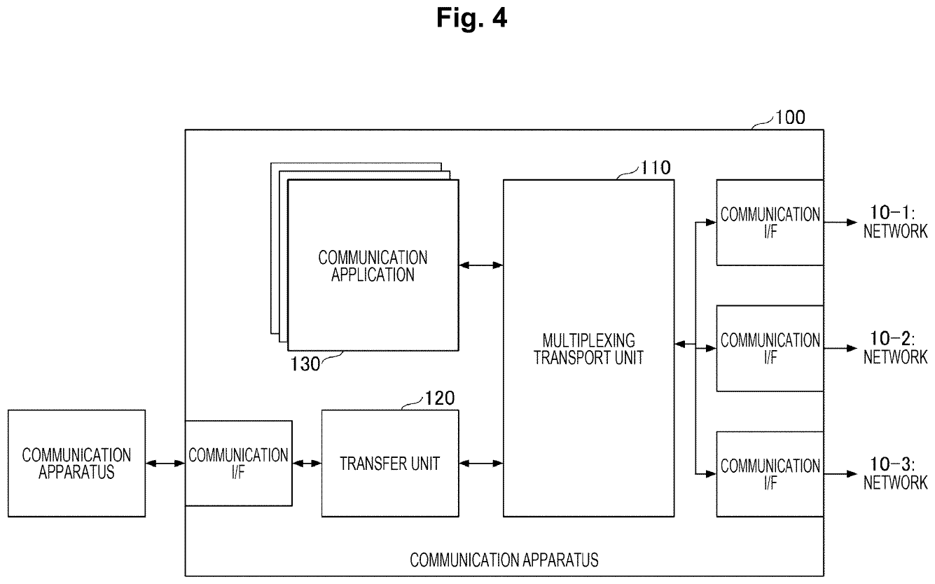

FIG. 4 illustrates a configuration example of the communication apparatus 100 according to the present embodiment. As illustrated in FIG. 4, the communication apparatus 100 includes one or more communication applications 130, a transfer unit 120, a multiplexing transport unit 110, and one or more communication I/Fs connected to an external network. Note that a configuration including only either the communication applications 130 or the transfer unit 120 may be adopted.

The communication applications 130 send communication data to the multiplexing transport unit 110, and the multiplexing transport unit 110 transmits the communication data to a communication apparatus that is a destination of the external network via one or more communication I/Fs.

In a case where the communication apparatus 100 is used for transferring communication data received from another communication apparatus by proxy, tunneling, or the like, the transfer unit 120 is included, and the communication data is transferred to the multiplexing transport unit 110 after performing transfer processing.

### Multiplexing Transport Unit 110

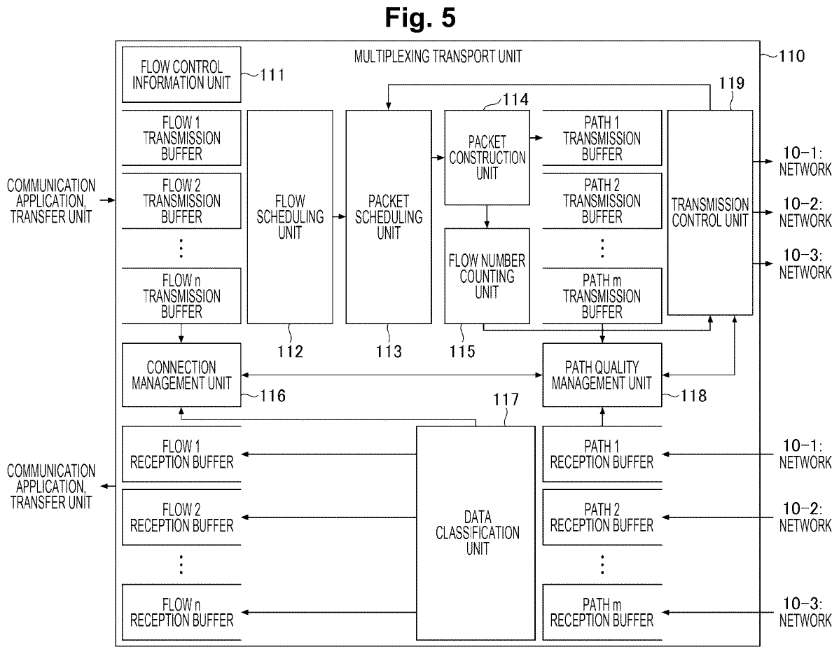

FIG. 5 illustrates a configuration example of the multiplexing transport unit 110. As illustrated in FIG. 5, the multiplexing transport unit 110 includes a flow transmission/reception buffer, a flow control information unit 111, a flow scheduling unit 112, a packet scheduling unit 113, a packet construction unit 114, a number-of-flows counting unit 115, a path transmission/reception buffer, a connection management unit 116, a path quality management unit 118, a transmission control unit 119, and a data classification unit 117. An overview of a function of each component is as follows.

The flow transmission/reception buffer buffers transmission/reception data for each flow. The flow control information unit 111 stores information defining a traffic control method for each flow.

The flow scheduling unit 112 determines a transmission flow. The packet scheduling unit 113 determines a transmission path. The packet construction unit 114 constructs a transport packet.

The number-of-flows counting unit 115 counts the number of latest used flows of each path. The path transmission/reception buffer buffers transmission/reception data for each path.

The connection management unit 116 processes connection path management of transport connection (such as TCP or QUIC) and control message transmission/reception, such as ACK.

The path quality management unit 118 calculates and manages quality (a throughput, RTT, a packet loss rate) for each path from information regarding each path transmission/reception buffer.

The transmission control unit 119 performs congestion control of each path and flow control, based on information from the path quality management unit 118 and the number-of-flows counting unit 115. The data classification unit 117 classifies data of each flow from a received packet.

### Flow Control Information and Determination Method

Flow control information stored in the flow control information unit 111 includes information such as a request congestion control algorithm of a corresponding flow, a request path, a request packet scheduling algorithm, whether or not a path can be changed, whether or not a flow can be multiplexed, and transmission priority, for example. The flow control information need not include all these items of information, and may include some of these items of information.

Although a method of setting the flow control information in the flow control information unit 111 is not limited to a specific method, there is a setting (registration) method as follows, for example.
The flow control information is registered directly or using an external API for each flow.
The flow control information is automatically set from a protocol type, an IP/port number, and a traffic pattern.
Setting is performed based on a QoS class or request information provided as a notification from a high-order protocol or an application, such as priority of HTTP.
Setting is autonomously performed from path quality.

### Basic Transmission Procedure

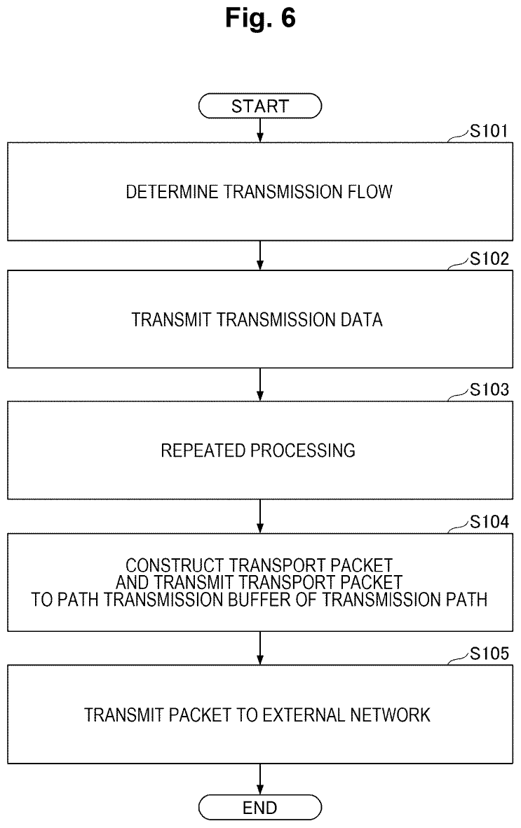

A basic transmission procedure executed by the communication apparatus 100 will be described with reference to the flowchart in FIG. 6.

In S101, the flow scheduling unit 112 determines a transmission flow. In S102, the packet scheduling unit 113 determines a transmission path with reference to flow control information of the transmission flow and a congestion control window and the amount of transmittable data in the flow control of the transmission control unit 119, and transmits transmission data to the packet construction unit 114.

In S103, in a case where the amount of transmission data is less than the amount of data that can be transmitted by one packet of the transmission path and the transmission flow allows multiplexing, the packet scheduling unit 113 repeatedly transmits transmission data to the packet construction unit 114 from a transmission buffer of a flow that can be transmitted by the same path. In a case where redundant transmission through a plurality of paths is performed, this processing is performed for each path.

In S104, the packet construction unit 114 constructs a transport packet by assigning a flow identifier to the transmission data of each flow and transmits the packet to a path transmission buffer of the transmission path.

In S105, the packet is transmitted from the path transmission buffer to an external network via a communication I/F connected to the path transmission buffer, based on transmission control performed by the transmission control unit 119.

Hereinafter, more detailed processing content will be described as first to fourth embodiments. The first to fourth embodiments can be performed in any combination.

### First Embodiment

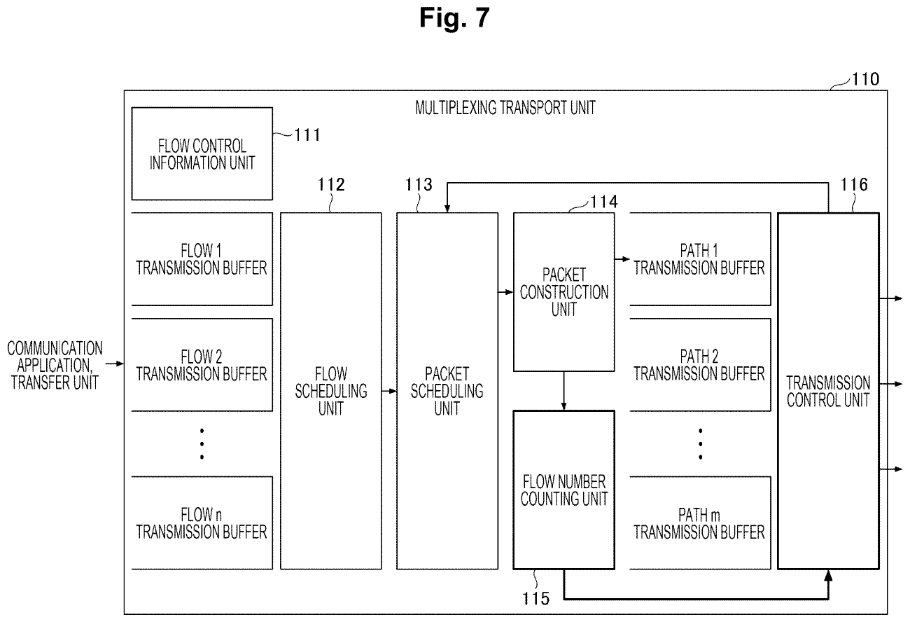

In a first embodiment, congestion window size control based on the number of active flows will be described. The control is control performed mainly by the number-of-flows counting unit 115 and the transmission control unit 116 illustrated in FIG. 7.

In this control, the transmission control unit 116 manages the congestion window size (cwnd), which is the amount of data that can be transmitted without receiving ACK, for each path. Also, the transmission control unit 116 adjusts an increase or decrease in congestion window size of each path using an existing algorithm or the like, such as CUBIC or BBR.

The number-of-flows counting unit 115 acquires the transmission flow information from the packet construction unit 114 and counts the number of flows transmitted in the latest specific period of time for each path. The transmission control unit 119 adjusts the amount of increase or decrease in congestion window size for each path in accordance with the number of flows acquired from the number-of-flows counting unit 115.

As an adjustment method, there is an adjustment method of increasing the congestion window size by taking fairness with other communication into consideration and defining a number obtained by multiplying cwnd by the number of flows as an upper limit, for example.

Through the control, it is possible to suppress a decrease in throughput when a plurality of different communication flows are multiplexed and transmitted in a single transport connection.

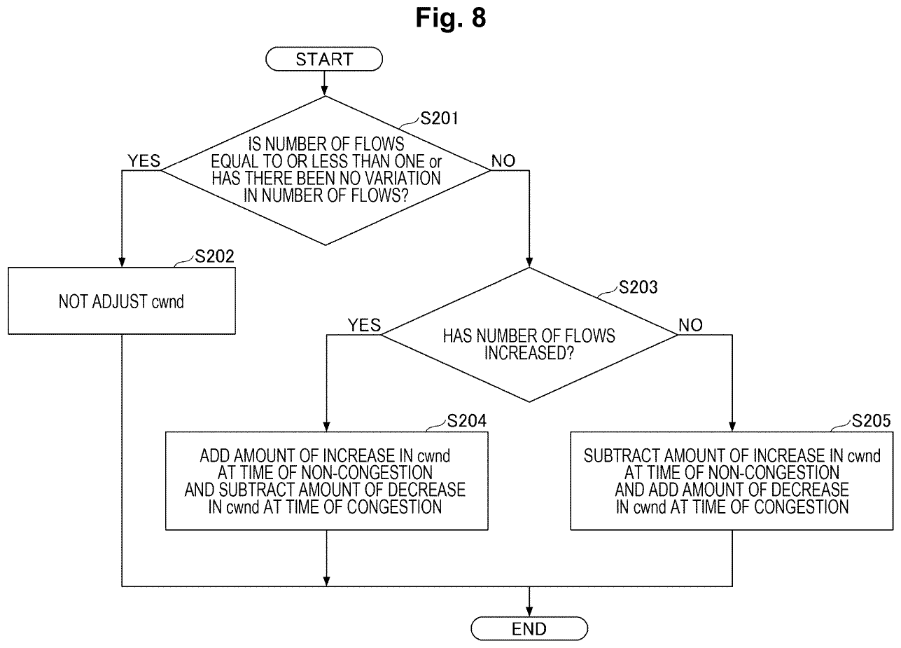

An example of a control procedure in the first embodiment will be described with reference to FIG. 8. In S201, the transmission control unit 116 determines whether or not “the number of flows is less than or equal to one or there has been no change in the number of flows”, based on the information from the number-of-flows counting unit 115, and moves on to S202 in a case of Yes or moves on to S203 in a case of No.

In S202, the transmission control unit 116 determines that the congestion window size is not to be adjusted. The transmission control unit 116 moves on to S204 if the transmission control unit 116 determines that the number of flows has increased in S203, or moves on to S205 if the transmission control unit 116 determines that there has been no increase in the number of flows (that is, the number of flows has decreased).

According to the congestion control algorithm used in TCP, QUIC, or the like, cwnd is increased to use a free band at the time of non-congestion (in a case where a packet loss or an increase in RTT has not occurred), and cwnd is reduced to avoid congestion at the time of occurrence of congestion (in a case where a packet loss or an increase in RTT has occurred), in general. In S204 and S205, the amount of increase or decrease in cwnd is adjusted. In other words, in S204, the transmission control unit 116 adds the amount of increase in cwnd at the time of non-congestion and subtracts the amount of decrease in cwnd at the time of congestion. In other words, the amount of increase or decrease in cwnd is expanded in S204. In S205, the transmission control unit 116 subtracts the amount of increase in cwnd at the time of non-congestion and adds the amount of decrease in cwnd at the time of congestion. In other words, the amount of increase or decrease in cwnd is reduced in S205.

### Second Embodiment

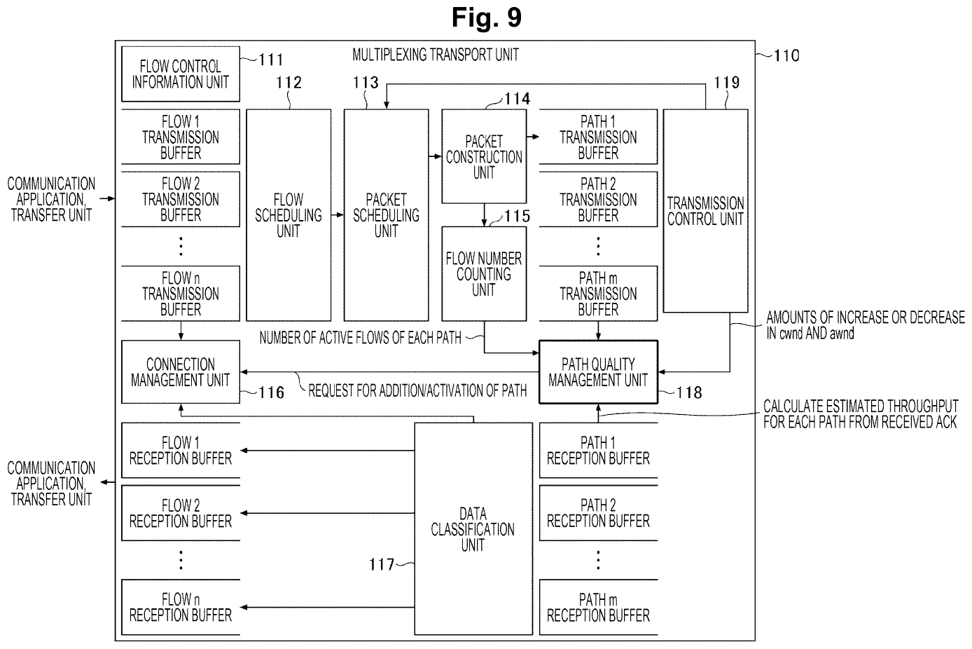

In a second embodiment, path addition control based on an estimated throughput will be described. This control is control executed mainly by the path quality management unit 118 illustrated in FIG. 9.

In a case where a relay apparatus in which congestion has occurred performs fairness control such as fair queueing in the first embodiment described above, it may be impossible to obtain a sufficient throughput through multiplexed communication flows. Thus, in the second embodiment, the communication apparatus 100 adds a logical path if the communication apparatus 100 detects that the throughput will not increase. Specific processing content is as follows.

The path quality management unit 118 monitors any one or more, or all, of the following values (1) to (3). The values to be monitored are also illustrated in FIG. 9.
(1) An estimated throughput of each path calculated from the amount of received ACK in the latest specific period of time of each path reception buffer
(2) The number of active flows of each path calculated by the number-of-flows counting unit 115
(3) cwnd acquired from the transmission control unit 119 and the maximum amount of transmittable data in flow control (the receive window size (rwnd) in TCP, MAX_DATA in QUIC, or the like)

If the path quality management unit 118 detects that the estimated throughput will not increase with respect to the amount of cwnd increased in a case where the number of active flows is greater than or equal to two as in the first embodiment, the path quality management unit 118 requests addition of a logical path from the connection management unit 116. However, in a case where the maximum amount of transmittable data (rwnd) in the flow control is smaller than cwnd, it is possible to determine that the throughput has not increased due to a reception buffer on the reception side, and the path quality management unit 118 thus determines not to add a logical path.

The connection management unit 116 that has received the request for addition of a logical path from the path quality management unit 118 uses an unused port number or backup line for any of the communication I/Fs and performs processing of newly connecting a counterpart communication apparatus and the logical path.

After the connection of the logical path is completed, the packet scheduling unit 113 offloads data of the transmission buffer of the flow to the new logical path. A plurality of logical paths may be prepared in advance between the communication apparatuses, and switching between activation and non-activation may be performed.

The packet relay apparatus performs fairness control on the new logical path through the control, and it is thus possible to obtain a desired throughput.

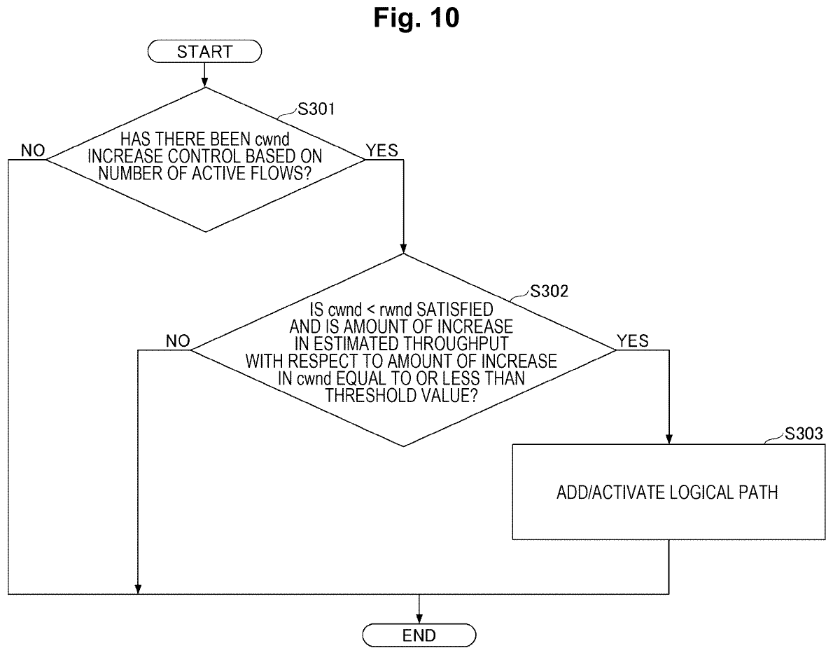

An example of a control procedure in the second embodiment will be described with reference to FIG. 10.

In S301, if the transmission control unit 119 determines that cwnd increase control based on the number of active flows has been performed, the transmission control unit 119 moves on to S302. In a case where no control has been performed, the processing is ended.

In S302, if the transmission control unit 119 determines that “cwnd<rwnd is satisfied and the amount of increase in estimated throughput with respect to the amount of increase in cwnd is less than or equal to a threshold value”, the transmission control unit 119 moves on to S303. If the transmission control unit 119 determines that this is not the case, the processing is ended.

In S303, the transmission control unit 119 adds a logical path or activates a logical path.

### Third Embodiment

In a third embodiment, a control scheme for constructing a logical path for each control, that is, control for adopting a request congestion control algorithm for each flow, will be described.

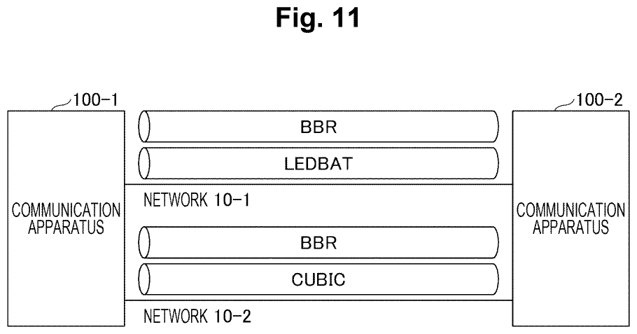

In regard to utilization of a different congestion control algorithm for each flow, LEDBAT using a free band is suitable for large capacity communication with low urgency level such as software updating, and BBR or Westwood of delay-based control is suitable for a wireless environment with high BER, for example. Specific processing content is as follows. Here, communication between the communication apparatus 100-1 and the communication apparatus 100-2 will be described as an example as illustrated in FIG. 11.

The connection management unit 116 of the communication apparatus 100-1 constructs a logical path with the counterpart communication apparatus 100-2 for each congestion control algorithm registered in the flow control information unit 111. In the example of FIG. 11, logical paths of BBR and LEDBAT are constructed in the network 10-1, and logical paths of BBR and CUBIC are constructed in the network 10-2.

The logical paths are distinguished by using a communication I/F and an IP address that the communication apparatus 100-1 has, for example, and changing a port number of a transport layer. Also, cwnd of each path is calculated based on the congestion control algorithm thereof.

The packet scheduling unit 113 of the communication apparatus 100-1 distributes flows to a path using the congestion control algorithm to be applied to the flow, based on the congestion control algorithm information used in the flow control information unit 111. For a flow with no designation of any congestion control algorithm, the packet scheduling unit 113 defines a logical path to be used as a default and uses the logical path.

### Fourth Embodiment

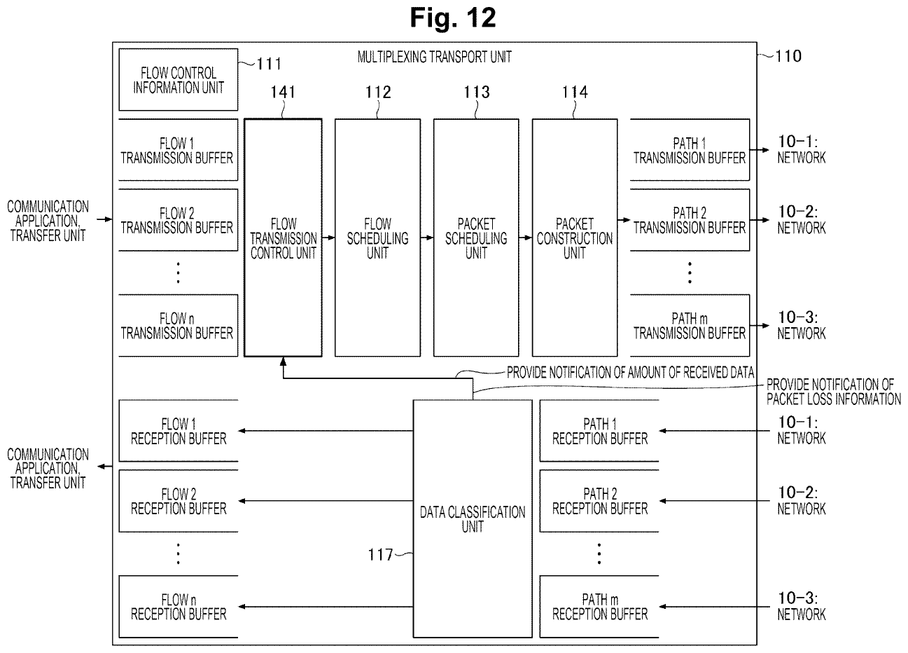

In a fourth embodiment, a control scheme for managing cwnd for each flow will be described. In the fourth embodiment, the communication apparatus 100 includes a flow transmission control unit 141 as illustrated in FIG. 12. FIG. 12 also illustrates a flow of information, which will be described below.

In the fourth embodiment, the flow transmission control unit 141 uses a different congestion control algorithm for each flow by managing cwnd for each flow. Specific processing content is as follows.

In the communication apparatus 100, data for each application received from a counterpart apparatus is stored in each flow reception buffer. In addition, the data classification unit 117 notifies the flow transmission control unit 141 of the amount of received data. The flow transmission control unit 141 updates cwnd of the corresponding flow, based on the amount of received data provided through the notification, reception intervals, and the like. The amount of received data is the amount of data of the flow received from ACK transmission to next ACK transmission in the communication apparatus on the reception side of the flow and can be recognized from ACK by the communication apparatus 100. The reception intervals are time intervals at which the communication apparatus 100 receives ACK.

Since packet loss information cannot be acquired from the flow reception buffer, the data classification unit 117 detects data loss in a data stream for each flow and provides a notification to the flow transmission control unit 141. The data loss in the data stream means that there is data that has not been able to be received by the communication apparatus on the reception side of the flow in the transmitted data stream.

Also, since it is not possible to detect data loss even by the above method in regard to a datagram flow, a transmission packet number of the datagram flow is held at the time of transmission, and determination can be made based on data loss in a received packet number.

In addition, the transmission control unit 119 may perform transmission control for each path similarly to the first to third embodiments for a datagram flow and a stream flow with no designation of any congestion control algorithm.

### Hardware Configuration Example

The communication apparatus 100 described in the present embodiments can be realized by causing a computer to execute a program, for example. This computer may be a physical computer or may be a virtual machine on a cloud.

Specifically, the communication apparatus 100 can be implemented by executing a program corresponding to the processing to be performed in the device by using hardware resources, such as a CPU and a memory included in the computer. The above program can be stored and distributed by being recorded in a computer-readable recording medium (e.g. portable memory). Furthermore, the above program can also be provided through a network, such as the Internet or an electronic mail.

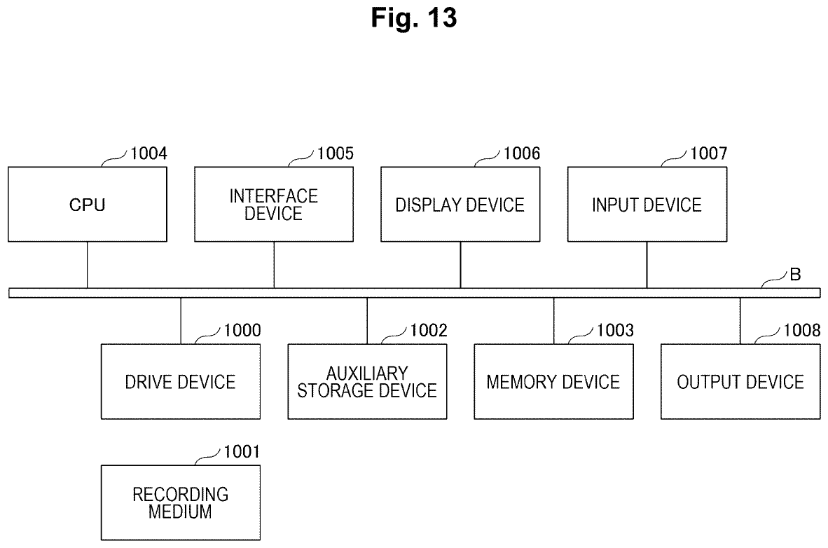

FIG. 13 is a diagram illustrating a hardware configuration example of the computer. The computer in FIG. 13 includes a drive device 1000, an auxiliary storage device 1002, a memory device 1003, a CPU 1004, an interface device 1005, a display device 1006, an input device 1007, an output device 1008, and the like, which are connected to one another by a bus BS. Note that the computer may further include a GPU.

The program for implementing the processing in the computer is provided by, for example, a recording medium 1001, such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is given, the memory device 1003 reads the program from the auxiliary storage device 1002 and stores the program. The CPU 1004 implements a function related to the communication apparatus 100 in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs an operation result.

### Summary of Embodiments

In the communication system according to the present embodiment, a plurality of communication flows are multiplexed within a single transport connection between communication apparatuses connected via one or more networks, and the multiplexed communication flows are transferred via the one or more networks.

The communication apparatus 100 constituting the communication system can hold traffic control metadata for each communication flow and determine a congestion control algorithm, a packet scheduling algorithm, a packet construction algorithm, and another QOS control scheme for each communication flow, based on the traffic control metadata.

The communication apparatus 100 counts the number of multiplexed flows for each path and increases or decreases the congestion window size, based on the number of flows. Also, the communication apparatus 100 calculates an estimated throughput from received ACK at the time of adjustment of the congestion window size based on the number of flows, and if it is detected that the throughput has not increased, the communication apparatus 100 generates or activates a new logical path.

Furthermore, the communication apparatus 100 can prepare, between the communication apparatuses, logical paths of different kinds of control such as congestion control algorithms and select a logical path to be used for each flow.

Furthermore, the communication apparatus 100 can manage the congestion window size for each flow to be multiplexed and can control the congestion window size, based on the amount of received data or the received data loss information for each flow.

### Concerning Effects

According to the technology of the present embodiments described above, it is possible to improve a throughput both at the time of congestion and in a case where fairness control for each flow works, in the communication configuration in which a plurality of flows are multiplexed using a transport protocol, such as MPTCP or MPTQUIC, and data transfer is performed through the same connection. In addition, it is possible to perform traffic control that is independent for each flow.

Regarding the above embodiments, the following supplements are further disclosed.

### Supplements

### (Supplement 1)

A communication apparatus that constitutes a communication system including a plurality of communication apparatuses connected via one or more networks, the communication apparatus having a function of multiplexing a plurality of flows within a single transport connection and transferring the flows, the communication apparatus including:
a memory; and
at least one processor connected to the memory,
in which the processor
counts the number of flows for each path in the transport connection, and
adjusts a congestion window size for each path, based on the number of flows for each path acquired by the number-of-flows counting unit.

### (Supplement 2)

The communication apparatus according to Supplement 1, in which
the processor provides an instruction to add or activate a path in response to detecting that the amount of increase in estimated communication quality of a path, the congestion window size of which has been increased, is less than or equal to a threshold value.

### (Supplement 3)

The communication apparatus according to Supplement 1, in which
the memory holds metadata for traffic control for each flow;
the processor constructs a path with a counterpart communication apparatus for each registered congestion control algorithm, based on the metadata and assigns each flow to a path using the congestion control algorithm to be applied to the flow, based on the metadata.

### (Supplement 4)

The communication apparatus according to Supplement 1, in which
the processor adjusts a congestion window size, based on the amount of received data or received data loss information for each flow.

### (Supplement 5)

A communication system including: the plurality of communication apparatuses according to any one of Supplements 1 to 4.

(Supplement 6)

A communication method executed by a communication apparatus that constitutes a communication system including a plurality of communication apparatuses connected via one or more networks, the communication apparatus having a function of multiplexing a plurality of flows within a single transport connection and transferring the flows, the communication method including:
counting the number of flows for each path in the transport connection; and
adjusting a congestion window size for each path, based on the number of flows for each path acquired in the counting of the number of flows.

### (Supplement 7)

A non-transitory storage medium storing a program that causes a computer to function as each component in the communication apparatus according to any one of Supplements 1 to 4.

Although the present embodiments have been described above, the present invention is not limited to such specific embodiments, and various modifications and changes can be made within the scope of the gist of the present invention described in the claims.

### REFERENCE SIGNS LIST

10 Network
20 Wide area network
100 Communication apparatus
110 Multiplexing transport unit
111 Flow control information unit
112 Flow scheduling unit
113 Packet scheduling unit
114 Packet construction unit
115 Number-of-flows counting unit
116 Connection management unit
117 Data classification unit
118 Path quality management unit
119 Transmission control unit
141 Flow transmission control unit
120 Transfer unit
130 Communication application
1000 Drive device
1001 Recording medium
1002 Auxiliary storage device
1003 Memory device
1004 CPU
1005 Interface device
1006 Display device
1007 Input device
1008 Output device

1. A communication apparatus that constitutes a communication system including a plurality of communication apparatuses connected via one or more networks, the communication apparatus having a function of multiplexing a plurality of flows within a single transport connection and transferring the flows, the communication apparatus comprising:
a processor; and
a memory storing program instructions that cause the processor to:
count a number of flows for each path in the transport connection; and
adjust a congestion window size for each path, based on the number of flows for each path.

2. The communication apparatus according to claim 1,
wherein the program instructions cause the processor to provide an instruction to add or activate a path in response to detecting that an amount of increase in estimated communication quality of a path, the congestion window size of which has been increased, is less than or equal to a threshold value.

3. The communication apparatus according to claim 1,
wherein the program instructions cause the processor to hold metadata for traffic control for each flow,
wherein the program instructions cause the processor to construct a path with a counterpart communication apparatus for each registered congestion control algorithm, based on the metadata, and
wherein the program instructions cause the processor to assign each flow to a path using the congestion control algorithm to be applied to the flow, based on the metadata.

4. The communication apparatus according to claim 1,
wherein the program instructions cause the processor to adjust a congestion window size, based on an amount of received data or received data loss information for each flow.

5. A communication system comprising: the plurality of communication apparatuses according to claim 1.

6. A communication method executed by a communication apparatus that constitutes a communication system including a plurality of communication apparatuses connected via one or more networks, the communication apparatus having a function of multiplexing a plurality of flows within a single transport connection and transferring the flows, the communication method comprising:
counting a number of flows for each path in the transport connection; and
adjusting a congestion window size for each path, based on the number of flows for each path acquired in the counting of the number of flows.

7. A non-transitory computer-readable recording medium having stored therein a program that causes a computer to perform the communication method according to claim 6.
